(19) United States
(12) Patent Application Publication
(10) Pub. No.: US 2008/0314807 A1
(43) Pub. Date: Dec. 25, 2008

(54) Systems and Methods For Treating Water

(76) Inventors: Max Rudolf Junghanns, Puebla Mexico (MX); Rafael A. Gonzalez, Salem, VA (US)

Correspondence Address: MICHAEL N. HAYNES, 1341 HUNTERSFIELD CLOSE, KESWICK, VA, 22947, US

(21) Appl. No.: 12/066,896

(22) PCT Filed: Sep. 14, 2006
(86) PCT No.: PCT/US06/35666

§ 371 Date: Jun. 9, 2008

Related U.S. Application Data
(60) Provisional application No. 60/720,014, filed on Sep. 23, 2005.

(51) Int. Cl. B01D 61/02

(52) U.S. Cl. 210/85; 210/321.72; 210/137; 210/251; 210/241

(57) ABSTRACT

Certain exemplary embodiments comprise a system, which can comprise a cage. The cage can define a chamber that can at least partially surround a tank. The system can comprise a plurality of water treatment components adapted to receive a non-potable water input and to provide a potable water output.

### CROSS-REFERENCES TO RELATED APPLICATIONS

This application claims priority to, and incorporates by reference herein in its entirety, pending U.S. Provisional Patent Application Ser. No. 60/720,014 (Attorney Docket No. 1086-003), filed 23 Sep. 2005.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a schematic diagram of an exemplary embodiment of a system 1000;

FIG. 2 is a photograph of an exemplary embodiment of a system 2000;

FIG. 3 is a photograph of an exemplary embodiment of a system 3000;

FIG. 4 is a photograph of an exemplary embodiment of a system 4000;

FIG. 5 is a photograph of an exemplary embodiment of a system 5000;

FIG. 6 is a flowchart of an exemplary embodiment of a method 6000; and

FIG. 7 is a block diagram of an exemplary embodiment of a system 7000.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
accept—receive.
activated—of a substance that is made reactive or more reactive.
activity—an action, act, deed, function, step, and/or process and/or a portion thereof.
adapted to—suitable, fit, and/or capable of performing a specified function.
addition—an act of adding one thing to another.
air—the earth's atmospheric gas.
and/or—either in conjunction with or in alternative to.
apparatus—an appliance or device for a particular purpose.
associated with—related to.
at least—not less than.
bag—a container made of a relatively flexible material.
be—to exist in actuality.
bottle—(n) a vessel adapted to substantially contain a liquid and adapted to be maneuvered by a single human without mechanical or human assistance. (v) to put into a container adapted to substantially retain a liquid.
by—via the use or help of.
cage—a box and/or enclosure enclosed on at least two sides, and potentially all normally vertically extending sides, by a grating of wires and/or bars that lets in air and light.
can—is capable of, in at least some embodiments.
cap—a protective cover and/or seal adapted to close off an end.
carbon—a naturally abundant nonmetallic element having an atomic number of 6 and an atomic weight of approximately 12.011.
chamber—an enclosed space or compartment.
clean—(v) to rid of dirt, rubbish, and/or impurities.
collapsible—capable of falling down or inward from a loss of support.
component—a constituent element and/or part.
comprises—includes, but is not limited to, what follows.
comprising—including but not limited to.
conductivity—an ability and/or power to conduct and/or transmit electricity.
control—(n) a mechanical or electronic device used to operate a machine within predetermined limits; (v) to exercise authoritative and/or dominating influence over, cause to act in a predetermined manner, direct, adjust to a requirement, and/or regulate.
cube—a three dimensional shape characterized by six sides, each of the six sides having a substantially similar appearance, each of the six sides substantially orthogonal to each adjoining side.
cubic—shaped in a manner resembling a cube.
cuboid—shaped in a manner resembling a rectangular parallelepiped.
define—to establish the outline, form, or structure of.
determine—to obtain, calculate, decide, deduce, and/or ascertain.
display—(v) to visually render. (n) an electronic device that represents information in visual form and/or a visual representation of something.
disposed—placed, arranged, and/or oriented.
external—relating to, existing on, and/or connected with the outside or an outer part.
filter—a permeable material through which a fluid is passed in order to separate the liquid or gas from particulate matter suspended therein.
flow—a continuous transfer.
forklift—an industrial vehicle with a power-operated pronged platform that can be raised and lowered for insertion under a load to be lifted and moved.
from—used to indicate a source.
further—in addition.
gun—a device resembling a firearm and/or cannon, the device adapted to project something, such as air, soap, and/or water, under pressure and/or at a relatively rapid velocity.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
hard real-time—relating to a system (or subsystem) having activities with hard deadlines, and a sequencing goal of always meeting all those hard deadlines. A system operating in hard real-time can suffer a critical failure if time constraints are violated. A classic example of a hard real-time computing system is an automobile engine electronic valve timing control system, in which an overly delayed or overly advanced control signal might cause engine failure or damage, due to one or more valve-piston collisions. Systems operating in hard real-time typically utilize instructions embedded in hardware and/or firmware.
hardness—a characteristic of water caused by the presence of various salts of calcium, and magnesium.
have—to possess or contain as a constituent part.
hot—characterized by a temperature above approximately 70 degrees Fahrenheit.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise and/or communicatively couple components such as one or more network interfaces, one or more processors, one or more memories containing instructions, and/or one or more input/output (I/O) devices, one or more user interfaces coupled to an I/O device, etc.
injector—a device adapted to force or drive a fluid into something.
input—something entering a system.
input/output (I/O) device—any sensory-oriented input and/or output device, such as an audio, electrical, chemical, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, sensor (electrical or chemical), and/or tactile pad, potentially including a port to which an I/O device can be attached or connected.
intelligent agent—a sensor comprising micro logic. The micro logic comprises operational logic and input/output parameters.
interior—a spatial location within a predetermined boundary.
is—to exist in actuality.
lamp—a device adapted to generate light.
lifting device—an apparatus or system adapted to vertically relocate a predetermined object from a first elevation to a distinct second elevation. A lifting device can be a crane, pallet jack, hoist, winch, and/or forklift, etc.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
membrane—a thin sheet of natural or synthetic material that is permeable to certain substances in solution.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
mixed oxidant system—a system adapted to provide a mix of disinfectants (e.g., chlorine, chlorine dioxide, and/or ozone, etc) for water disinfection.
more—a quantifier meaning greater in size or amount or extent or degree.
mount—(n) that upon which a thing is attached. (v) to directly and/or indirectly couple, fix, and/or attach on and/or to something.
move—to change a position and/or place.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
non—not.
non-destructively—of, relating to, and/or being a process that does not result in damage to the subject material and/or product and/or results in such minimal damage that the subject material and/or product can be re-used for its intended purpose.
one—a single entity.
output—(n) something produced and/or generated. (v) to provide, produce, manufacture, and/or generate.
ozone—an allotrope of oxygen, O₃. Ozone is a relatively reactive oxidizing agent that can be used to purify water.
package—(v) to place in a container.
partially—to a degree, but not necessarily totally.
particle—a small piece or part. A particle can be and/or be comprised by a powder, bead, crumb, crystal, dust, grain, grit, meal, pounce, pulverulence, and/or seed, etc.
platform—a raised surface that is at least partially planar.
plurality—the state of being plural and/or more than one.
polish—to refine or purify.
potable—fit to drink by a human.
predetermined—established in advance.
prior—preceding in time or order.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
programmable logic controller (PLC)—a solid-state, microprocessor-based, hard real-time computing system that is used, via a network, to automatically monitor the status of field-connected sensor inputs, and automatically control communicatively-coupled devices of a controlled industrial system (e.g., actuators, solenoids, relays, switches, motor starters, speed drives (e.g., variable frequency drives, silicon-controlled rectifiers, etc.), pilot lights, igniters, etc.) according to a user-created set of values and user-created logic and/or instructions stored in memory. The sensor inputs reflect measurements and/or status information related to the controlled industrial system. A PLC provides any of: automated input/output control; switching; counting; arithmetic operations; complex data manipulation; logic; timing; sequencing; communication; data file manipulation; control; relay control; motion control; process control; distributed control; and/or monitoring of processes, manufacturing equipment, and/or other automation of the controlled industrial system. In addition to controlling a process, a PLC might also provide control of information, such as via outputting information to speakers, printers, monitors, displays, indicators, etc., and/or rendering information, such as via reports, notifications, and/or alarms, etc., such as via a Human-Machine Interface (HMI). Because of its precise and hard real-time timing and sequencing capabilities, a PLC is programmed using ladder logic or some form of structured programming language specified in IEC 61131-3, namely, FBD (Function Photograph), LD (Ladder Diagram), ST (Structured Text language), IL (Instruction List) and/or SFC (Sequential Function Chart), or potentially via a general purpose hard-real-time-aware programming language, such as ADA. Because of its hard real-time timing and sequencing capabilities, a PLC can replace up to thousands of relays and cam timers. PLC hardware often has good redundancy and fail-over capabilities. A PLC can be adapted to provide information to, and/or receive information from, a user via a user interface.
provide—to furnish, supply, give, convey, send, and/or make available.
Radio Frequency Identification Device (RFID)—a technology wherein electromagnetic or electrostatic coupling in the RF portion of the electromagnetic spectrum is typically used to transmit signals to automatically identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be communicated with information devices.
receive—to gather, take, acquire, obtain, accept, get, and/or have bestowed upon.
recommend—to suggest, praise, commend, and/or endorse.
rectangular parallelepiped—a parallelepiped of which all faces resemble rectangles.
regulate—to control, direct, and/or adjust according to a particular specification and/or requirement.
remove—to eliminate, remove, and/or delete, and/or to move from a place or position occupied.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
reverse osmosis—a method of producing pure water by forcing saline and/or impure water through a semipermeable membrane across which salts and/or impurities cannot pass.
said—when used in a system or device claim, an article indicating a subsequent claim term that has been previously introduced.
seal—to shut close; to keep close; to make fast; to keep secure; to prevent leakage.
sensor—a device or system adapted to detect or perceive automatically.
shape—a characteristic surface, outline, and/or contour of an entity.
signal—information, such as machine instructions for activities, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal can be synchronous, asynchronous, hard real-time, soft real-time, non-real time, continuously generated, continuously varying, analog, discretely generated, discretely varying, quantized, digital, continuously measured, and/or discretely measured, etc.
single—existing alone or consisting of one entity.
skid—a pallet for loading or handling goods.
storage—(n) a device adaptable to hold and retain something. (v) the act of placing and retaining an object in a container.
store—to place, hold, and/or retain something in a vessel.
sub-plurality—the state of being plural and/or more than one and comprising at least a portion of a larger identified plurality.
substantially—to a great extent or degree.
subsystem—a system that is comprised in a larger system.
support—to bear the weight of, especially from below.
surround—to encircle, enclose, and/or confine on several and/or all sides.
system—a collection of mechanisms, devices, data, and/or instructions, the collection designed to perform one or more specific functions.
tank—a container adapted to hold and/or store a solid and/or fluid.
transmit—to send as a signal, provide, furnish, and/or supply.
treat—to subject to a process, treatment, action, and/or change.
treatment—a method of handling and/or dealing with something.
ultrafiltration—a method of removing non-dissolved particles such as mud, silt, organics, bacteria, and/or viruses from water via a filter device, such as a membrane.
ultraviolet—of or relating to the range of invisible radiation wavelengths between approximately 4 nanometers and approximately 380 nanometers.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc. A user interface can be communicatively coupled to a programmable logic controller.
via—by way of and/or utilizing.
wash—to cleanse, using water or another liquid.
water—a substance expressed chemically as H₂O.
wherein—in regard to which; and; and/or in addition to.

### DETAILED DESCRIPTION

Certain exemplary embodiments provide a system, which can comprise a cage. The cage can define a chamber that can at least partially surround a tank. The system can comprise a plurality of water treatment components adapted to receive a non-potable water input and to provide a potable water output.

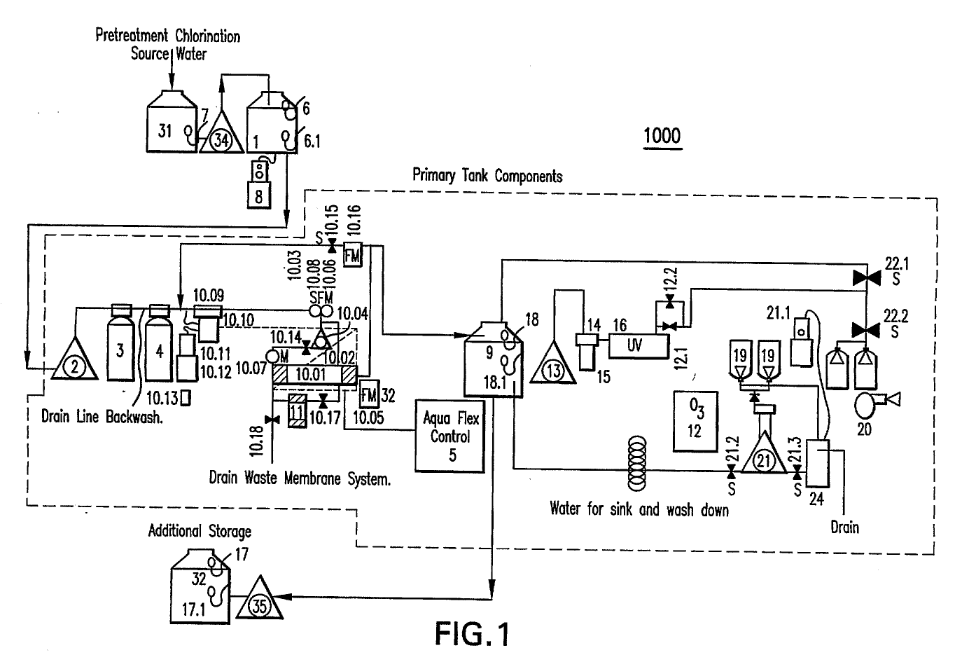

FIG. 1 is a schematic diagram of an exemplary embodiment of a system, 1000, which can provide a relatively small, lightweight, portable, and/or all-in-one, potable water treatment, production, and/or bottling system.

Certain exemplary systems can comprise a base tank with structure support (BTSS) 9. BTSS 9 can be and/or comprise an Ecobulk MX 1000, which can be obtained from Schutz Container Systems of North Branch, N.J. BTSS 9 can comprise a molded plastic bulk container or storage tank, which can be supported by a pallet and/or base. The storage tank can be at least partially surrounded by a structural cage, grid, mesh, overlay, and/or skeleton (herein referred to as the “cage”). The cage can provide structural support for certain components of system 1000, and the tank can provide storage for the potable water produced by such components.

The storage tank of BTSS 9 can be made from extrusion blow-molded high density polyethylene (HDPE) that can have a surface modified plastics (SMP) protective barrier and/or can be relatively resistant to damage caused by ultraviolet (UV) light. The storage tank can be substantially cubic-shaped and/or cuboid, with rounded corners for easier interior cleaning. The base of BTSS 9 can form a substantially planar surface for supporting and/or elevating the storage tank, and/or can be made from high density polyethylene, wood, steel, aluminum, stainless steel, and/or a composite material. The base can comprise plural slots adapted for access by lifting device, and/or can comprise a leveling mechanism, such as legs welded to the base and having variable height capabilities for leveling the base and/or storage tank when uneven support surfaces are encountered. The base can comprise plastic corner protectors to protect the storage tank, and/or can comprise handles to allow for manually carrying BTSS 9.

The cage of BTSS 9 can be formed from four substantially planar vertical walls and a substantially planar top interconnecting those sides, provided as a grid-like arrangement of steel rods and/or tubing, which can be painted and/or galvanized. The cage can be attached to the base, such as via bolts, screws, clamps, and/or welding, etc. The cage can comprise plastic corner protectors to protect the storage tank.

BTSS 9 can be designed to withstand transportation and handling stress as outlined in various Department of Transportation (DOT) and Food and Drug Administration (FDA) regulations, such as 47 C.F.R. Section 171.8. BTSS 9 and/or any of its components can withstand temperature conditions as low as zero degrees Fahrenheit. BTSS 9 and/or any of its components can withstand a drop test, such as that described in DOT and United Nations (UN) Transportation Regulations, in which BTSS 9 having its storage tank filled with water is dropped from a loading dock height. BTSS 9 can be designed to protect the storage tank from damage that would cause a leak and to protect the base itself from damage that might render BTSS 9 non-movable and/or unusable. BTSS 9 can be designed to provide structural side and top support for the possible stacking of other BTSS units, bulk containers, and/or storage tanks that might weigh upwards of 3000 pounds each.

Various system components can be attached to the cage and/or base of BTSS 9. These components, many and/or all of which are described herein, can comprise one or more zeolite and/or particle filters, nano and/or ultrafiltration membranes, activated carbon filters, anthracite filters, cartridge filters, pressure gauges and/or controls, probes and/or probe assemblies, intelligent agent sensors, float sensor assemblies, reverse osmosis membranes, ultraviolet systems, mixed oxidant systems, ozone systems, platforms for filling of bottles, filling injection assemblies, bottle washer assemblies, chemical injectors and/or pumps, chemical dissolving and/or storage tanks, circulating and/or transfer pumps, sink and/or sample ports, electronic control panels, programmable logic controllers (PLCs), modems, electrical panels, switches, and/or data logging systems, etc.

Various system components and/or supports therefore can be attached to the outside of the sides and/or top of the cage, and/or to the outer surface of the base, via various methods such as welding, clamps, bolts, screw fittings, and/or glue fittings, etc. Plumbing, which can be constructed from NSF grade rigid plastic piping, can fluidically connect certain system components and/or can enhance the structural support of those components. Plumbing can be held to the cage via bolted clamps.

A one piece, L-shaped, stainless steel panel, which can serve as a washing, filling and/or capping platform for a bottling subsystem, can be installed near a vertical mid-point of one wall of the cage. This platform can define holes and/or connections for piping to attach to the platform.

Certain exemplary systems can weigh approximately 700 to approximately 1500 pounds for a fully functional system, which can comprise the storage tank, overlay, controls, and processing components, system 1000 can be movable via a lifting device. System 1000 can be pre-wired, pre-plumbed, and/or comprise color-coded connections to allow for rapid deployment and/or ease of installation.

Once assembled, certain exemplary embodiments of system 1000 and/or BTSS 9 can measure approximately 195 cm (approximately 78 inches) long, approximately 135 cm (approximately 54 inches) wide, and/or approximately 2.2 m (approximately 86 inches) in height (this height can be less than approximately 80 inches in certain systems). This can allow for relatively easy transportation of system 1000 and/or a relatively small footprint once installed.

System 1000 can be integrated around BTSS 9 and/or can comprise the following components depending on water inlet source:
An external centrifugal and/or submersible pump 34 can be adapted to pump raw water from the supply source if non-pressurized water is present. Controls of the pump can be integrated as part of a control system 5.
A chemical metering pump 8, such as those manufactured by LMI of Ivyland, Pa., Walchem of Holliston, Ma., and/or Pulsafeeder of Rochester, N.Y., can provide approximately 150 gallons of chemical injection of chlorine or oxidant (e.g., an oxidant from a mixed oxidant system) for pretreatment at less than approximately 150 pounds per square inch (psi). The mixed oxidant system can be a modular system obtained from MIOX Corporation of Albuquerque N. Mex. The mixed oxidant system can utilize salt, water, and electricity to generate a mixed oxidant, which can comprise chlorine, chlorine dioxide, and/or ozone, etc. The chlorine solution can be injected via a tee connection and/or injector. Either solid, liquid or vapor chlorine can be utilized. The pump, chlorine solution tank 8.1, piping, and/or injector tee can be mounted and/or pre-plumbed within and/or to BTSS 9. Chlorine solution tank 8.1 can be utilized to hold the concentrated chlorine for disinfection and/or can be pumped by chemical metering pump 8. Chemical metering pump 8 and chlorine solution tank 8.1 can be controlled and managed by control system 5. The chlorine can be regulated by the control system 5 to attempt to achieve a proper chlorine contact time. Thereby, control system 5 can attempt to achieve a proper bacteria, virus and/or cyst kill time. Chlorine solution tank 8.1 can have a capacity of approximately 20 liters or can be of such capacity to hold an adequate capacity for treating a quantity of water to be processed.
The chlorine treated water then can be placed in an external holding tank, referred to as chlorinated water holding tank (CT) 1, which can be formed from rotationally molded polyethylene, and/or a heavy-duty plastic tank constructed of high density polyethylene (HDPE) or low density polyethylene (LDPE) with large radius corners for easy cleaning. Float-type level sensors 6 and 6.1, which can be connected to system 1000, can help system 1000 monitor the water level CT 1 for a low level or a high level. For example, based on reported water levels, system 1000 can switch on or off components, such as pump 34, which can supply water from a water source, such as a raw water storage tank (RWT) 31, well water, lake water, and/or other source of water being supplied to system 1000 for chlorination. Alternatively, or in addition, system 1000 can shut on or off a pumping subsystem and/or the overall water treatment system in case the water level gets too low or becomes insufficient for proper water production. The inter-relationship of the pump, chemical feed system, and/or tank can be designed so that sufficient contact time is available for chlorine disinfection.
An external centrifugal and/or submersible pump 2 can pump the chlorinated water from CT 1 through filtration systems 3 and 4. Control of pump 2 can be integrated as part of control system 5.
One or more support platforms, which can be made of carbon steel painted with paint and sealed with a cover of rubberized antislip material, can be welded to the sides of the base and/or cage of BTSS 9. One such a platform can provide the support for filtration systems 3 and 4, chlorine solution tank 8.1, a washing solution tank 24, a detergent addition system 21.1, an antiscalant solution tank 10.12, plastic drawers for keeping caps and accessories of the plant, and/or a rinse and wash pump 21, etc. Another such platform can provide support for other components, such as a UV lamp 16, and/or a water sampling manifold, etc.
Filtration system 3 can be made from fiberglass and can be attached using a support method of the platform as base and band rings attached to the cage of BTSS 9. Filtration system 3 can be relatively resistant to corrosion and can comprise a tank having a thermoplastic inner liner. The tank of filtration system 3 can have a maximum working pressure of approximately 150 psi and a maximum working temperature of approximately 120 degrees Fahrenheit. The fiberglass resin for the tank of filtration system 3 can be approved under American National Standards Institute (ANSI)/National Science Foundation (NSF) Standard 44.
Filtration system 3 can be filled with zeolite filter media with a density of approximately 55 pounds per cubic foot and/or a particle sizes between approximately 14 mesh and approximately 40 mesh. The filter media can be designed to filter suspended solids having a diameter of approximately 10 microns or greater. The specific gravity of the product can be approximately 2.2 grams per cubic centimeter. A bed depth of the filter media can be between approximately 36 and approximately 48 inches (approximately 91 and approximately 122 centimeters). The free board or space of the filter media between the top of the filter media and top of the tank can be approximately 50 percent of the bed. The service flow rate can be approximately 12-20 gallons per minute (gpm) per square foot (approximately 45-76 liters per minute (lpm) per square foot). Other media, such as sand or multimedia, can be used to remove particles depending on the type of source water being supplied.
A fleck control valve can be attached to and/or modified to operate filtration system 3 under the control of control system via a sensor regulator sensor reporting to control system 5. As particles build up in the filter media, the pressure can increase and when the set point for bed surface area is reached, control system 5 can start an automatic backwash of the bed to remove material on the bed surface. This backwash period can be controlled based on total bed surface and/or can be part of the design of system 1000. Other subsystems of system 1000 that might be flushed can be coordinated via control system 5 to insure proper backwash of each subsystem without impacting the optimization of the production of system 1000. In certain exemplary embodiments, filtration system 3 can be installed prior to CT 1 or after CT 1 depending on organic material found and removal standards. If material is reactive with chlorine and solids are produced, filtration system 3 can be installed after CT 1.
A carbon filter tank (CFT) 4 can be attached to the base platform. CFT 4 can be filled with granular activated carbon (GAC) manufactured by Calgon Carbon of Pittsburgh, Pa., Norit of Amersfoort, The Netherlands, and/or Chemviron of Ashton, England. The GAC can provide removal of odor, organic, micropollutants, overall organics, residual oxidants, and/or other material that may impact taste and color. The density of GAC can be in the range of approximately 450 to approximately 600 kilograms per cubic meter. Moisture can be in the range of approximately two percent to approximately four percent. The GAC can comply with ANSI/NSF drinking water standards. The contact time of the GAC can be at least one minute in order to remove the material discussed above, as well as residual chlorine prior to proceeding to reverse osmosis or other separation system.
A fleck control valve for CFT 4 can be attached and/or modified to operate under the control of control system 5 via a sensor regulator sensor reporting to control system 5. A backwash of the carbon bed can resist compacting of the GAC and/or can flush build up from surfaces of the GAC. This backwash can be controlled in a similar fashion to filtration system 3.
A filter housing 10.09 and a corresponding cartridge filter 10.10 can be a standard blue or clear Pentek filter housing with a Pentek CP5 cartridge filter (each available from Pentek Filtration Inc., of Sheboygan, Wi.). Filter housing 10.09 can be connected to the cage. Cartridge filter 10.10 can comprise a pleated cellulose polyester or similar material. Filter housing 10.09 can be designed to receive water from the carbon filter and/or can be used for the removal and entrapment of sediments and/or carbon fines of nominal size of approximately five micron or greater.
In the case the water is to be desalinated, demineralized, or separated from dissolved solids, a reverse osmosis or membrane subsystem can be attached to and/or supported by the cage. The reverse osmosis system can comprise a brackish or desalination membrane with a bypass and/or recirculating system design. The reverse osmosis subsystem can comprise a solenoid valve 10.03, which can be a type Evolutionary Concepts Inc. (ECI) WO/Stem Control 953 Series Normally Closed or similar type solenoid valve and/or can be designed to protect against undesired flow when backwashing or other component action is being taken or if chlorine contamination is picked up by sensors prior to membrane. Thus, this subsystem can prevent the membrane from being damaged by such water. The solenoid can be controlled and/or regulated by control system 5.
A pressure switch 10.08, such as a pressure switch obtained from Square D of Palatine, Ill., along with a pressure gauge 10.06 (which can have a range between approximately zero and approximately seven kilograms per square meter and/or a psi read out) can be installed and/or attached in system 1000. Pressure switch 10.08 can provide pressure control and/or flow control to increase a probability that a predetermined minimum pressure and/or flow are flowing into the membrane subsystem, thus attempting to avoid damage to the membrane. The software of control system 5 can consider the control and regulation of flows, as well as design characteristics of the membrane.
A high pressure pump 10.04, such as a multistage electric pump manufactured by Grundfos of Olathe, Ks., or other high pressure pump manufacturer, can be used for supplying water to the membrane system at up to approximately 600 psi depending on type of membrane and salinity of water. The control of the pump and/or pressure regulations can be managed by control system 5.
A ball bronze valve 10.14 located after the pressure pump can be an aid for controlling the water pressure sent to the first membrane housing. The valve and control can be regulated via a motorized valve assembly controlled by control system 5
A pressure gauge 10.07 having a predetermined range (such as approximately 0-300 or approximately 0-1000 psi) can be installed online with the water flow between high pressure pump 10.04 and reverse osmosis membrane 10.01 as a visual aid for calibration of the reverse osmosis subsystem. Pressure gauge 10.07 can be a center back or bottom mount gauge.
A membrane housing 10.02 can be made of polyvinyl chloride (PVC) or reinforced fiberglass or stainless steel, in a quantity varying from approximately one to approximately six units. The end caps on the sides of membrane housing 10.02 can have approximately two orifices, the pressure side orifice can comprise female national pipe threads (NPT), and the product or permeate orifice can comprise female NPT threads.
When more than one membrane housing is used, membrane housing 10.02 can be installed in a series arrangement comprising up to four membranes, or four in series plus two in parallel when six membranes are installed on BTSS 9.
Inside membrane housing 10.02, one or more reverse osmosis membranes 10.01 can be installed, typically with one per membrane housing 10.02. Each membrane can be an approximately 4 inch by approximately 40 inch cylinder TriSep element, such as one of TriSep membrane number 4040-SB20-TSA, 4040-X201-TSF, 4040-ACM5-TWF, 4040-ACMS-SSF (available from TriSep Corporation of Goleta, Ca.), or similar membranes for any type of water, to demineralize, and/or desalinate water. In certain exemplary embodiments, the reverse osmosis membrane can be a FilmTec membrane obtainable from Dow Chemical Co. of Midland, Mich.
All permeate or product water (PW) outlets from the membrane housing 10.02 can be inter-connected and/or supply one stream of treated water to the storage tank of BTSS 9.
Along with the permeate interconnections, a raw water by-pass (RWBP) coming from a needle valve (which can be of bronze or stainless steel construction) after the approximately five micron filter cartridge housing can be connected to provide an option of mixing salts for a desired salt content level. This can be controlled by a solenoid valve system that can comprise a mixed water solenoid valve 10.15 and/or a inlet water solenoid valve 10.03, either of which can be an ECI W/Stem Control 955 Series Normally Closed, or similar, connected in parallel with PVC schedule 80 and/or flexible piping. These two valves can provide a preconfigured amount of salt content to the water depending on the type of water to be produced (emergency, 20 liter bottle, small size bottle, etc.). By being able to blend reverse osmosis product water, which can be relatively low solids water, similar to distilled water, with filtered water that has been particle filtered by filtration systems 3 and 4, a small amount of hardness and/or salt can be added to the water to improve flavor and/or potable drinking quality. This combination of PW, RWBP, and mixtures thereof can be called finished water (FW), which can be stored in the BTSS 9 or additional finished water storage tank (AST) 32 providing increased storage capacity.
In some models, the RWBP can be connected directly to a flowmeter having a predetermined operating range (such as approximately 1-5 gpm or approximately 0-20 lpm). The RWBP outlet can be connected to the PW or permeate flowmeter.
In certain exemplary embodiments, both flows, the RWBP and the PW or product flow(s) from the membrane(s), can be connected before a flow sensor 10.05, such as a Blue & White F550 Panel Mount flow sensor (available from Badger Meter, Inc. of Milwaukee, Wis.) or similar, and can measure within ranges such as approximately one to five and/or approximately one to 50 gpm.
After the last membrane housing in the reject outlet, a tee diversion with two bronze or PVC valves can follow. A recirculating valve 10.17 can be adapted to restrict a recirculation flow back to the pressure pump inlet and a reject valve 10.18 can be to control a rejection flow. The rejection flow can be a flow that is wastage or wastage water (WW) from the membrane separation process. Control system 5 can be used to optimize membrane performance.
PW and/or RWBP can be directed to AST 32 and/or BTSS 9, depending on the model and water storage capacity chosen.
AST 32 can be used and/or can be interconnected with many similar tanks to provide additional storage capacity for the finished treated water. Tanks comprised in system 1000, because of their design and leg structure, can be adapted to be stacked to reduce an occupied space and/or can be pre-plumbed with level sensors. Thus, a multitank storage design can be achieved. All lower tank ball valves can be interconnected to each other and/or connected to a centrifugal pump 35 as a transfer pump to BTSS 9. In certain exemplary embodiments, a submersible pump can be installed in one of the lower tanks as a transfer pump to BTSS 9. This interconnection can provide an expansion that is integrated within control system 5. AST 32 and/or BTSS 9 can comprise high-level and/or low-level sensors, such as sensors 17, 17.1, 18, and 18.1, to effect level control of stored water. The storage tank of the BTSS 9 can be the primary recipient tank of finished water (FW).
A submersible and/or centrifugal circulating pump 13 (which can be approximately one horsepower (HP) in certain exemplary embodiments) can be installed in BTSS 9 for continuous recirculation of the stored water. Circulating pump 13 can allow for further biological control with such components as ultraviolet and/or ozone, plus can pressurize finished water for utilization with a bottling system component of system 1000 and/or for distribution of the water to the end user in the case of emergency water and/or drinking water to a hotel, facility, clinic, or such other premise that is using system 1000 for potable water generation. Circulating pump 13 can be controlled via control system 5.
A filter housing 14, such as a Pentek Filter Housing or similar with a Pentek CP 1 Pleated Cellulose Polyester or similar cartridge (PN 10.15) filter can be installed by bolts and/or clamps on BTSS 9 for post treatment sedimentation and/or bacteria control. The filter of filter housing 14 can have an ability to filter waterborne particles having a nominal size of approximately one micron or greater. The filter can be attached and/or piped within the structure of system 1000 and its components.
After passing filter housing 14, water treated by system 1000 can be provided to a UV lamp purification subsystem 16, which can comprise a stainless sleeve (such as approximately 52 millimeters in diameter by approximately 95 centimeters long) and a lamp (such as a lamp of approximately 400 watts). UV light subsystem 16 can comprise inlet and outlet connections having male threaded NPT fittings and can be installed for sanitization and/or biological control of all the finished and stored water in BTSS 9 and any of the other additional tank components such as AST 17. The lamp can be controlled and/or monitored via control system 5.
After UV light system 16, a further polishing step for additional protection and/or taste enhancement can be installed, such as an ozone system 12. Ozone system 12 can be enclosed in an electrical panel box of control system 5 and/or can operate with the aid of an injection assembly comprising a bypass valve 12.2 and/or a venturi injector 12.1 (such as a 978 code venturi injector obtained from Mazzei Injector Corporation of Bakersfield, Calif.). The ozone system can be controlled and/or regulated via control system 5.
A snap head filler system (SHF) 22.3, designed for bottling multiple types of containers including plastic bottles, bags and/or glass bottles, etc. can be installed as part of system 1000. SHF 22.3 can be individually designed for the type of bottle being filled. For example, a bottle having approximately one liter of storage capacity can have a different head filler assembly as compared to a bottle having approximately one gallon of storage capacity. In certain exemplary embodiments, SHF 22.3 can be utilized in a broad range of applications using BTSS 9. Thus, system 1000 comprising SBF 22.3 can become a bottling plant or in the case of bags an emergency response unit.
If a bottling adaptation is utilized for system 1000, control system 5 can provide a one-button changeover via software that can be adapted to allow an operator of system 1000 to select the changeover function. This can be done via a display panel with graphical icons of the possible options that system 1000 might be used for, such as “Facility Water”, “Bottling”, “Emergency”, etc. Within each primary button, additional buttons corresponding to a process can be displayed. As an example, icons of one liter bottles can indicate that system 1000 is being used as a bottling plant and one liter bottles are being filled.
In this case, a recirculating flow of BTSS 9, which can be continuously treated with ozone and/or ultraviolet, can send water through the SHF 22.3 by closing a solenoid fill valve 22.1 (such as an ECI Normally closed 955 Series or similar of a nominal one inch pipe size) and/or by opening a solenoid fill valve 22.2 (such as an ECI W/Stem Control 955 Series Normally Closed or similar). After solenoid valve 22.2, a tee connection comprising two PVC ball valves can follow. The two PVC ball valves can be utilized for a calibration of one or more instruments associated with system 1000.
For different sized bottles and/or bags, after the two PVC valves, system 1000 can comprise a bottle specific filling Assembly (BFA) 22.4 with the proper snap-on head that can fit the type of water bottle being filled. Thus, system 1000 can be adapted for a wide range of capabilities and/or uses.
For a bottling process using BTSS 9, a stainless steel platform can be bolted to the cage of BTSS 9. This platform can provide a support system for the bottles being filled and/or can allow for a special head to be attached to BTSS 9, such as a bottle washing/rinsing system and/or a capping platform for capping the filled bottles.
The platform can be installed within the structure at such a level that will allow the operator to safely move the bottles and/or bags from one area, for example after being filled, to another area, such as to capping, without having to lift the bottle significantly, thus allowing a relatively ergonomic motion and relatively safe movements for the operator.
The platform can comprise a wash station and/or a sampling port area for the operator to wash his/her hands and/or to provide a sampling point for sampling the water for chemical and/or quality testing by the operator. The platform can also comprise an area for storing caps for the bottling process.
For exemplary systems comprising a bottling subsystem, a washing and rinsing subsystem can be installed using a pressure pump (such as a pump of approximately one HP or above), which can have two suction options and/or one outlet to the washing and rinsing nozzles. A first suction can be controlled by a solenoid valve 21.2 which can be connected to the outlet in the bottom of BTSS 9. A second suction can be connected through a solenoid valve 21.3 to a washing solution tank 24, which can have a storage capacity of approximately five gallons. In certain exemplary embodiments, washing solution tank 24 can be a polyethylene-closed tank. An outlet of the pressure washer pump can be connected to two wash/rinse water nozzles 19.
Wash/rinse connections included with the bottling system can be connected to the structure and/or the platform. The pumps for the wash and rinse cycles can be controlled via control system 5. The wash/rinse connections can comprise various snap-on head assemblies that can allow for the type of bottles that are being filled to be washed and/or rinsed prior to filling.
A hot air sealing gun 20, such as a Black and Decker blower (available from Black and Decker of Hunt Valley, Md.) or similar, can be used to manually shrink the contractible seals used as warranty seals when needed. Hot air sealing gun 20 can be installed in one of the sides of system 1000 where the manual capping process can take place. The platform and structure of system 1000 can provide a holding clip or vessel for a gun as well as storage for shrink wrappers.
When no bottling filler subsystem is installed, the water outlet from the treated primary water tank or storage tank, depending on design, can be a single rapid connector for a hose or pipe (such as a hose or pipe having a nominal diameter of approximately one inch). An additional pump service can be controlled via control system 5 to provide distribution of the water if higher pressurization is desired than that provided by circulating pump 13.

The above descriptive information of certain components of an exemplary system describes certain control system components and/or methods that can be implemented in hardware, firmware, and/or software and is referred to herein as control system 5. A descriptive overview of an exemplary software and hardware design of control system 5 follows:
System 1000 can provide control systems, components, and/or methodologies for controlling a packaged potable water treatment plant and/or system that can comprise one or more pumps, motor drives, filters, membranes, monitors, probes, sensors, valves, actuators, biological treatment subsystems, and/or chemical dilution and/or addition subsystems. Control system 5 can integrate the control of the any and/or all components of the water treatment plant. Control system 5 can provide capabilities for diagnostics, prognostics, data logging, reporting, and/or management of such components in an integrated manner.
Because water purification can be a complex process and can often involve careful control and/or management of the many sub-processes that can be utilized to produce potable water from a wide range of sources (e.g., contaminated water, seawater, brackish water, well water, river water, and/or city water, etc.), control system 5 can allow for multiple components to work together in a seamless manner to insure desired and/or proper water quality, minimize waste, reduce worker decision-making and/or input, increase efficiency, reduce cost, and/or reduce system maintenance and/or failure, etc.
The components and/or parts that can be used to produce potable water are commonly chosen according to specifications for a particular application for which those components are to be employed. For example, a filter might be chosen to pass a nominal particle size, such as for an X micron particle to pass through the filter at Y flowrate. The range of nominal particle sizes can be broad or narrow in scope depending on, for example, filter bed, media selection, and/or quality of water. This filter component can be integrated with other components, each with characteristics designed for the corresponding sub-process. For example, a selected chlorine biological treatment can utilize a certain level of chlorine and contact time to properly destroy pathogens. This might result in different flows than other subsystems, thus other performance metrics can cause other components and/or their performance metrics to be less than optimal at the actual operating conditions for overall water purification. An operator might control such a system manually, or with limited input, attempt to control the multiple components, and/or attempt to balance the operation of the overall water treatment plant to optimize its efficiency and/or performance.
Via consideration of the characteristics of the individual components, system-wide operating conditions, integration of real-time diagnostics, performance evaluation, and/or prognostics techniques, within a framework of an automatic control and software integration, control system 5 can provide an automated real-time control system for managing, optimizing, and/or significantly enhancing operation and/or performance of the water treatment system. Thus, a balance between input (raw water) and output (potable water) can be optimized throughout the corresponding steps to perform the water treatment operation.
Control system 5 can utilize an intelligent agent scheme (hardware, firmware, and/or software design) for which the various components, operating options, physical entities, and/or operational requirements can be modeled and/or presented with software agents that serve as proxies for the respective machine, entities, and/or their performance factors. Intelligent agents can monitor, execute commands, extend capabilities, adapt dynamically, and efficiently integrate with existing and/or designed systems. In certain exemplary embodiments, intelligent agents can be dynamically reconfigured. These agents can be designed to interact with one another and/or facilitate converging needs and controls to collaborate and negotiate process objectives in an optimal manner. This can be accomplished via feedback from the operation of each component. For example, this feedback can comprise information from one or more intelligent agents and/or sensors such as flow, RFID data, contact time, level, pressure, pH, oxidation reduction potential (ORP), chlorine level, conductivity, salinity, color, voltage, amps, ozone level, dissolved solids content, water-borne biological agent content, dissolved metal (e.g. Fe) content, pump cavitation, and/or ultraviolet lamp intensity, etc. For example, microorganisms can be detected and/or monitored via a laser-based system obtained from JMAR Technologies, Inc. of San Diego, Calif. Control system 5 can comprise a sensor array capable of characterizing incoming water, assessing the performance of each processing step, and/or confirming the quality of the potable water produced. The sensor array can be adapted to provide relatively broad-spectrum coverage of fluid condition, contaminant detection, and/or contaminant identification. A sensor/microbial sensor array may be obtained from Rockwell Automation of Milwaukee, Wis.
The components for each subsystem, their variables, and their set-points can be programmed into the software. As an example if the chlorine tank requires a contact time of approximately 30 minutes with a chlorine level of approximately 0.5 milligrams per liter (mg/l), system 1000 can integrate the chlorine holding tank volume, pump flow, chlorine dosage metering pump, and/or chlorine solution chemical tank into the process to insure that the pump pumping water from the source does not exceed the holding time, and/or that the chemical pump injecting the chlorine feeds at a rate sufficient to achieve the approximately 0.5 mg/l residual while at the same time an ORP sensor and/or chlorine probe can measure the actual residual. System 1000 can also dissolve chlorine at a rate sufficient to keep the chlorine chemical tank stocked with concentrated chlorine so that the metering pump maintains a proper and/or desired chlorine feed. Control system 5 can metaphorically serve as a traffic policeman that can allow certain items to move and take priority over other items based on conditions specified by logic programming built into control system 5. Thus, a multi-component integration can be achieved. Control system 5 can be adapted to control such processes as valve setting, membrane cleaning, chemical treatment, disinfection, and/or monitoring, etc. Control system 5 can be communicatively coupled to a network (e.g. the Internet) for remote monitoring and troubleshooting of system 1000.
This integration of agents can be used to monitor each component and/or can provide cost information, quality objectives versus projected design factors, data collection, service requirements, and/or optimization of the plant's performance. This can mean that relatively high-level overall water treatment system objectives (e.g., ease of use, providing potable water at lower cost, balancing the process, life cycle costs, maintenance, downtime, health risks, and/or efficiency, etc.) can manage and/or control the lower-level objectives required by the individual components of the water treatment system. By integrating the information and operation in a high-level objective design, the control system can provide additional degrees of freedom to management and/or operators of system 1000.
Control system 5 can share and/or obtain information from a variety of sources. At the operator level, limited input can be required and/or available. This can comprise, as an example, the type of bottle container the plant is filling, such as five gallon containers. The potentially desirable feature for the operator and/or user can be the easy-to-use, automated, pre-configured control display system (PCDS). Control system 5 can provide screen images and/or menus of the options the plant is capable of producing and/or the operator can select options presented within the PCDS structure to optimize the entire plant operation.
Control system 5 can obtain information from attached components to determine if the configuration of the control system layout is appropriate for operator input. If not, the operator can be provided with a display error message describing what conditions can be met to achieve a particular goal. At the end-user level, information that can be shared can comprise run time, system performance, quality levels, input/output of water, maintenance frequency, maintenance requirements for an automatically controlled and/or operator controlled system, cost factors, and/or limited programming capabilities, etc. At the manufacturer level, remote information sharing can be provided to allow for remote modification of individual components, troubleshooting, monitoring, and/or performance evaluation, etc. A multi-tier security feature, which can comprise password protection, biometrics, authentication, certification, encryption, tunneling, etc., can provide a safety factor for water quality reliability.
Control system 5 can comprise the capability for remote monitoring of the water treatment system and/or its subsystems. This capability can comprise the ability to operate a video camera system that can record video and/or audio and/or transmit video and/or audio wirelessly and/or via the Internet to a remote location.
The sharing of information (e.g., process information, operator communications, audio and/or video information, etc.) can be accomplished by system 1000 through a variety of techniques including networking a host computer to a remote computer, such as via a client-server information exchange over a network such as a local area network, wide area network, Internet, and/or intranet, etc., any portion of which can be wired and/or wireless, etc. This information sharing and/or communication feature can allow for network-based management and/or optimization of water treatment systems and/or control systems on a remote, global, and/or enterprise-wide basis. In certain exemplary embodiments, system 1000 can comprise and/or be communicatively coupled to a satellite communications link. The satellite communications link can be adapted to transmit information related to the operation and/or maintenance of system 1000 via a network. In certain exemplary embodiments, control system 5 can comprise and/or be communicatively coupled to an information device comprising a simulation model of system 1000. One or more mechanical and/or functional characteristics of system 1000 can be mathematically modeled in order to improve operations of system 1000. The simulation model can integrate mathematical models of power, electrical, chemical, and/or hydraulic system components, etc. The simulation model can simulate operation of system 1000 under conditions of different water quality, equipment degradation and failure, and/or different operating strategies, etc.
Motors and pumps comprised by system 1000 can each utilize variable frequency drives (VFDs) for motor and pump operation. This technology can provide for reduced energy consumption and unique control options to extend the life of system components. Furthermore, developmental work by Rockwell has shown that VFD data can provide motor and/or pump diagnostics without downstream instrumentation. Motor control can be dynamically altered to uniquely extend the life of system components such as pumps. VFDs can respond to varying conditions in system 1000 to improve the operation of system 1000.
Control system 5 can be adapted to implement a multi-objective optimization strategy. An objective of system optimization and/or ergonomic design might change based on objectives, equipment condition, and/or expected duty cycle, etc. For example, control system 5 can be adapted to attempt to optimize the energy cost for each gallon of water produced. Alternatively, control system 5 can be adapted to attempt to promote a longest possible operation of system 1000 without maintenance—possibly without regard for production rate and/or energy costs. In certain exemplary embodiments, control system can be adapted to maximize an amount of water produced during a given time interval. The water produced might exceed a nominal rating of system 1000 while reducing chances of an unexpected system failure.

Control system 5 can comprise a custom-built panel comprising any of the following subsystems, any function of which can be implemented in hardware, firmware, and/or software:
A PLC such as a MicroLogix 1200 Controller (available from Rockwell Automation of Milwaukee, Wis.). The MicroLogix 1200 has a relatively small footprint and can comprise one or more of the following features:
   Expansion capabilities for up to 136 Input/Outputs;
   A 20 kilohertz (KHz) Pulse Train Output for servo motor control;
   Master/Slave capabilities for SCADA control programming;
   Dual communication port capabilities and Ethernet/ISP integration;
   Windows environment programming and ASCII (read/write);
   Peer-to-Peer communication including SCADA and RTU;
   Memory modules;
   Programmable Limit Switch allowing for High Speed Counter;
   Communication module including Ethernet/IP Interface, DeviceNet Interface, DH-485 Interface, DF 1 Half-Duplex slave protocol, and/or DF 1 Full Duplex protocol;
   Rail-mounted module panel for upgrades and integration;
   Software keying of modules to resist incorrect positioning;
   Multipower capabilities including AC/DC relay, 24V DC, and 120V voltages;
Integrated control system 5 software utilizing Microsoft's 32 bit programming for all programming and graphical user interface (GUI) software;
International Electrotechnical Commission (IEC) Single Freethrough Circuit Prewiring system;
Multi-channel current/voltage Analog Input Modules;
Panel View 300 Micro from Rockwell providing graphical display for data output and operator input through display function keys; and/or
Control system 5 software programming for control and operation of the plant system; etc.

Certain exemplary systems can utilize inlet water from any of many different sources, such as municipal, city, well, canal, lake, pond, tertiary treated waste water, brackish, spring, river, sea, and/or any clear and/or high salt content or mineral water that might not comprise primary or secondary waste water.

Certain exemplary systems can comprise any of the following subsystems and/or components:
Chlorination subsystem, which can comprise a tank and measuring probe with appropriate contact time designed as part of a package to achieve disinfection and/or residual values;
Particle filtration subsystem for sediment removal rated up to approximately 20 microns;
Organic filtration subsystem, which can be designed to remove organic material and/or halogens from water prior to processing. This subsystem can comprise activated carbon, KDF, and/or other organic removal material;
Pre-process filtration subsystem, which can be rated for removal of particulates of a diameter of up to approximately five microns to remove sedimentation and/or possible post-treatment bacteria and/or polish pre-treated water;
Demineralization subsystem, which can be designed for reverse osmosis, nanofiltration, ultrafiltration, distillation, and/or ion exchange for production of treated water;
Post production blend valve subsystem, which can be designed to control salt mix through bypass blending in order to add desired salts back to the water;
Integrated storage tank subsystem for storing treated water prior to final polishing and conditioning;
Post production water filtration subsystem rated to remove particulates of a diameter of up to approximately one micron, which can provide a relatively high water quality;
Ultraviolet disinfection subsystem, which can provide continuous treatment of treated water to yield a relatively good storage condition of the treated water (no residual disinfection);
Ozone generation subsystem, which can provide a secondary barrier protection to treated water (short term residual);
Control silver ion dosage subsystem with electronic control, which can provide for addition of ions of silver in order to provide long term shelf life of finished product in bottling applications (depending on needs and local regulations);
Automatic and continuous recirculation subsystem for use with the post production water filtration subsystem, ultraviolet disinfection subsystem, and/or the ozone generation subsystem. The automatic and continuous recirculation subsystem can be used when bottles are not being filled or water is not being dispensed, which can assist in maintaining a relatively high level of water purity;
A control subsystem, which can comprise a panel mounted network programmable controller with multipoint digital I/O and analog capabilities. The control subsystem can provide simple function logic push button operation for ease of use depending on operation if bottling urban water production or facility water production. The control subsystem can be preprogrammed to balance all components of the operation based on limited operator input;
System 1000 and/or the control subsystem can provide full network interface capabilities including 10/100/1000 Base-T Ethernet, digital subscriber loop (DSL), cable modem, and/or T1 level connectivity and/or access speeds, mini-Deutsche industrie norm (DIN) RS-232 port connectivity, remote controller monitoring, peer-to-peer communications in multi-tank facility, e-mail communication, modem communications with auto baud detection, and/or wireless link connectivity, etc.;
The control subsystem(s) can comprise a multi-function display panel with analog and digital read-out capabilities. The panel can comprise an option for multi-language menu assistance. The panel peer-to-peer interconnectivity can allow for multiple units to be connected and/or controlled from one main controller. The panel can be adapted for on-board data entry and operator programming with display buttons. A flexible bit-map design can allow for custom layout design of plant for actual operation;
Control system 5 can comprise control software, which can be configured as a 32-bit software package designed to control all components of system 1000 while allowing input by the operator for local operating conditions. Control system 5 software can provide operational control of systems with diagnostics, communication, and/or intuitive user interface built in. The software can operate in any Microsoft Windows environment. Control system 5 software can provide full data logging of operations for troubleshooting, maintenance, and/or reporting needs. Control system 5 software can comprise diagnostics with remote servicing built in. Control system 5 software can utilize operating system upgrades for Windows and/or alternative operating systems, and/or can be configured as a 64-bit software package;
To accommodate non-bottled water applications, system 1000 can comprise pressurization pumps and/or valves as needed for the distribution of the finished water to a small village, city, hospital, facility, restaurant, and/or resort, etc. Sensors for this purpose can be integrated into system 1000 software and electrical design;
To accommodate emergency applications, system 1000 can comprise an emergency response package, version, and/or subsystem, which can comprise collapsible pre-storage and chlorination tanks, emergency pumps for filling from water source, generators, and/or post distribution spigots for operating system 1000 on an emergency basis. Such components can be designed in an emergency response version of system 1000, but might not be part of a non-emergency version of system 1000. The emergency response version of system 1000 can comprise reinforcements and/or hooks attached to the overlay and/or skeleton to allow for delivering system 1000 via helicopter, plane, and/or parachutes to remote regions;
The emergency response package, version, and/or subsystem can be included as part of a military version of system 1000, which can comprise additional specifications as desired by a military organization;
In certain exemplary embodiments, system 1000 can comprise Radio Frequency Identification (RFID) components on certain components as desired, specified, and/or required by end user; etc.

In certain exemplary embodiments, system 1000 can process and/or treat water via one or more of the following components, subsystems, activities, and/or functions:
Chlorination of the incoming water, which can effect biological removal with an appropriate residual and/or contact time in an external tank to provide proper disinfection;
First stage filtration of the chlorinated water to remove solids having a diameter in a range of up to approximately 20 microns, which can reduce a relative probability of system blockage;
Exposure to activated carbon or organic removal media, which can remove chlorine material and/or organics from the water prior to further processing;
Second stage filtration, which can reduce a probability that particles from the carbon treatment or small sediments carry through into a pre-treated storage tank. This can improve a relative cleanliness of the tank and/or reduce a probability of clogging of reverse osmosis/membranes by sediments;
Salt removal via one or more of various methods, such as reverse osmosis, which can remove viruses, bacteria, organics and/or most of the salt content from the water, and/or can produce a relatively high quality drinking water;
An automatic blending subsystem, which can add slight amounts of salts, natural and/or synthetic, to the finished water to provide for an improved taste quality in cases where this is desired, specified, and/or required, such as for bottling or resort facility operations;
The treated water can be stored in an integrated system tank for further polishing and/or treatment;
Continuous polishing of treated water to remove particles having a nominal diameter greater than approximately 0.35 to 1.0 micron, which can provide bacteria control and/or particle filtration;
Continuous disinfection of treated water in the storage tank with ultraviolet light, which can provide biological control;
Ozone treatment of finished water, which can provide for longer term protection of the tank and water;
Silver ion dosage with electronic control, which can provide for addition of ions of silver to improve bottle water storage shelf life and/or if local regulations require such treatment;
Continuous recirculation when not filling bottles or distributing water, which can assist in preserving water purity; and/or
The bottling unit can comprise multiple filling heads capabilities, which can allow for one plant to be utilized in the filling and/or bottling of multiple packages including bottles and/or bags, with relatively easy setup and takedown. The multiple filling heads and control package can be designed for a single operator to be able to handle the complete filling and bottling with maximum ease; etc.

In certain exemplary embodiments, system 1000 can comprise chemical dosing subsystems that can use dry chemicals for long term shelf life of chemicals used by the plant and also can allow for ease of shipment worldwide. The chemical components can be as follows:
Dry chlorine canister system for chlorination of incoming water.
Dry detergent canister system for wash water of bottles prior to filling.
Dry anti-scalent for scale and deposit control on membrane system.
Dry activated carbon canister.

The anti-scalent can be RO 515 dry solid treated as manufactured by Xelera, Inc. Salem, Va. The anti-scalent can be obtained in containers, such as containers having a volume of approximately one gallon and weighing approximately 15 pounds each. The anti-scalent can be dissolved in water and/or diluted at a ratio such as approximately 15 parts water to one part anti-scalent. Any dry subsystem can comprise an automatic dissolving and/or dosing for proper chemical residual control for items requiring dissolving prior to use. The operator can change the canisters as needed or specified in the operational manual. The automatic dissolving subsystem can comprise proper level control and/or sensors, which can assist in dissolving material at proper rate. Chemical sensors within the treatment plant can insure that chemicals are being added at recommended rates.

In certain exemplary embodiments, system 1000 can comprise a filling subsystem that can provide a simple-to-use multi-level filling package that can allow for a broad range of bottles and/or bags to be filled by one plant. The bottles can be of sizes and/or dimensions desired, determined, and/or required by a local market. The bottles can be reusable and/or disposal. Caps for the bottles can be screw-type, pressure-type, etc., as desired, determined, and/or required by a local market.

The filling subsystem can provide for single operator filling of small returnable or non-returnable bottles and/or plastic bags without the need to utilize a cardboard package system. In certain exemplary embodiments, 20 liter bottles can be filled in cycles of two-at-a-time. The 20 Liter bottles can be located by hand below two filling heads that can be provided downstream of solenoid valve 22.2.

The filling subsystem can comprise a washing and filling kit, which can comprise a smart tray, loading box, unloading box, rinsing manifold, rinsing tray, and/or filling manifold, etc.

The loading box can be a topless box that can stand somewhat shorter than the bottles (e.g., approximately 2 inches to 4 inches shorter) and can hold a 6×4 matrix of upright bottles that can be loaded by hand. Once the loading box is loaded, the bottles can be trapped by a smart tray that has pear shaped holes in a 6×4 matrix arrangement provided in two layers of square plates. The two layers can have the pear shaped holes opposite to each other, and can be surrounded by a frame that allows the upper plate to slide over the other, opening large holes when slid fully to one side and closing the diameter of the holes when slid to the other side. The smart tray can trap the bottles by their necks and/or can handle 24 bottles at a time.

The rinsing tray can be a two holed tray, measuring approximately 40-50 centimeters (cm) by 20-30 cm by 3-5 cm, that can match the two holes from the washing-rinsing subsystem and/or can be attached above the washing holes retain spillage from the bottles while rinsed.

The rinsing manifold can comprise a set of 24 nozzles, arranged as a 6×4 array, with one water entrance in the bottom. The rinsing manifold can comprise a Radio Frequency Identification (RFID) tag so that control system 5 can recognize which rinsing manifold is connected. With the aid of an end cap, one of the two holes in the wash-rinse subsystem can be closed and the second hole can be used for holding the rinsing manifold.

The filling manifold can be a box with a series of ball valves and nozzles with two rapid connection connectors on the sides to match the two regular 20 liter bottles filling nozzles and connect replacing the universal connection of each nozzle. The filling manifold can comprise two side legs that can match above the smart tray along each of the 4 rows. It also can have an RFID tag (or a wired identifier module) for providing control system 5 with an indication of what filling accessory is attached.

The unloading box can be a box similar in size as the loading box, but with approximately four liners opened in a flower shape to be able to align the bottles filled with water and unload them from the smart tray at approximately one point above a surface.

For 1.5 liter bottles, the arrangement of the rinsing manifold, the smart tray, the loading box, and/or the unloading box can be in sets of four by three pieces. Other sizes of bottles and arrangements can be adapted in arrangements compatible with the size of the bottle and/or the size of the master box when packaged.

The filling subsystem need not require that the operator re-adjust the process when switching from one filling type to another. Instead, upon pressing a single button or by hardware recognition, either wired or Radio Frequency Identification (RFID) tags, the integrated software program can handle the change.

In certain exemplary embodiments, system 1000 can be controlled by control system 5, which can comprise a pre-wired, pre-programmed programmable logic controller (PLC) that can be comprised an integrated panel. The filling manifold, the PLC, and/or panel can comprise displays and/or logic adapted to:
change the process program depending on the package type being filled in a user friendly LCD display;
provide an automatic balance of water processing time and bottle filling time, which can attempt to achieve a complete wash, fill, and bottle cycle that is less than a predetermined time, such as approximately one minute;
process bottles from approximately 330 ml (approximately 11 oz) to approximately 20 liters (approximately five gallons) in the bottling plant mode;
automatically rinse new bottles for a predetermined time period, such as approximately three to approximately five seconds;
automatically disinfect returnable bottles and/or rinse prior to automatically filling for approximately 30 to 45 seconds. When filling small non returnable bottles, the filling procedure can start after pressing a button of control system 5. Valve 22.1 can be opened slowly to prevent splashing of water. Valve (PN 22.2) can be opened for a predetermined period of time (such as approximately 5 to 20 seconds), to allow the first row of bottles in the smart tray to fill. After filling, a waiting time (such as approximately three to five seconds) can allow the operator to move the filler head and the second row of bottles can be filled. This operation can be repeated until a predetermined count of preprogrammed rows of bottles per smart tray has been filled. After completion of filling of predetermined rows, this procedure can end;
allow the entire process to be controlled by an operator with one push button input;
allow the operator to provide and/or manage intermittent filling, washing, and/or continuous filling in a fully automated fashion without having to adjust system 1000 components;
provide emergency stop functions in case an operation of system 1000 needs to be stopped;
reduce a probability of overfilling or short filling of bottles;
manage level control of system components and/or tanks without significant operator involvement;
receive automatic feedback of water quality from sensors for logging data, tracking, troubleshooting, and/or reporting;
automatically control pumps to attempt to balance water quality, chemicals, and/or flows;
dampen a hydraulic response of system 1000 to a switching of controls;
stop pump feeding membrane systems in cases where insufficient pressure develops, thereby reducing a relative probability of a system failure;
measure, determine, and/or display analytical water qualities, including whether measured values are within a predetermined control range. If water quality falls outside predetermined parameters, automatic error logs and/or alarms can be generated; and/or
activate or deactivate bottling capabilities as desired. For non-bottling systems, the bottling program need not be active but other functions of the water process system such as an on-demand pressure switch can be active, etc.

In certain exemplary embodiments, system 1000 can comprise integrated components and/or subsystems utilizing control system 5 software that can result in a one-button operation of system 1000. Thus, with one button the operator can balance system 1000 multi-components.

As described earlier, the operator can manually make adjustments to any of many components to optimize system 1000. In system 1000, many items can be monitored and/or adjusted for maximum efficiency. In the example previously given, an operator was adjusting the contact time of chlorine in the chlorine contact tank and can make adjustments and/or balance at least five components. When implemented in a full water treatment process, the adjustment can be time consuming and/or inefficient. As one item becomes balanced, the process of balancing that one item can un-balance another item, component, and/or subsystem. In certain exemplary embodiments, each component's performance and/or design can be pre-programmed. The operator can be given a one-button choice, for example, “Bottle Water”, “Facility Water”, “Emergency Water”, etc. For each choice, a sub-screen can appear that will allow the operator to select the best choice for the process the operator is implementing. For example, if “one-button bottling” is selected, then a sub-screen can appear that shows graphically the types of bottles available. The operator can select the proper bottle size and system 1000 can identify the snap-on head to utilize for filling. The operator can accept the choice and install the head. Once the operator completes the action, the operator can press “Start” and system 1000 then can start the pump, and/or regulate the flow, pressure, chemical residuals, membrane operation, ultraviolet, ozone, etc., depending on the components. Thereby the operator can be free from trying to match performance of the single component with the performance of system 1000. Thus, the one button process can improve the operation by regulating and/or controlling the process. Control system 5 also can allow for personnel with various levels of training and/or education to be able to operate system 1000.

In certain exemplary embodiments, the operator can select the mode of operation, e.g., “bottling”, “facility”, or “emergency”, and a secondary screen can allow the operator to select a method of administration of finished water. For example, in “bottling” mode, the operator can be provided a screen that would allow for selection of the bottle type. By selecting the bottle type, system 1000 could calibrate and regulate all the individual components for processing the water. The “facility” option can allow selection of sub-facilities, such as hotel, hospital, manufacturing plant, and/or community, etc., each of which can have predetermined and/or selectable water quality specifications and/or requirements. For the “emergency” mode and/or option, the secondary screen can comprise a selectable distribution method, such as “local” for distribution via spigots and “pressurization pump” for filling vessels.

In certain exemplary embodiments, control system 5 software can be adapted to monitor the process to improve relative performance reliability. Certain components and/or each component can be measured in hard real-time and/or data can be locally logged for reporting and/or downloading. The reliability monitor can measure such variables of system 1000 such as pressures, ORP (oxidizing reduction potential), pH, conductance, chlorine, UV intensity, and/or ozone, etc. The reliability monitor can measure actual run time, cleaning cycle time, total water processed, total bottles processed, RFID data, and/or type of bottles if used in the bottling mode. For facilities and other such sites, system 1000 can monitor the total and/or instantaneous water usage for cost monitoring purposes.

If an alarm condition develops, system 1000 can provide a local alarm to the operator with screen instructions on how to correct problem. If additional assistance is required, a modem/Internet communication module comprised by system 1000 can allow for data transmission and/or off-site troubleshooting, such as by the equipment manufacturer.

An information device, such as a computer of control system 5, and/or a computer coupled thereto, can comprise any of numerous components, such as for example, one or more network interfaces, one or more processors, one or more memories or other machine-readable mediums containing machine instructions, one or more input/output (I/O) devices, and/or one or more user interfaces coupled to an I/O device, etc.

The exemplary embodiment of system 1000 illustrated in FIG. 1 can comprise:
1. Chlorinated water holding tank (CT);
2. Pump to filter tank;
3. Filtration system;
4. Carbon filter tank (CFT);
5. Control System;
6.1 Low level chlorine tank float-type level sensor;
6.2 High level chlorine tank float-type level sensor;
7. Low level raw water tank float;
8. Chemical resistance metering pump;
8.1 Chlorine solution tank;
9. Base tank with support structure (BTSS);
10.01. Reverse osmosis membrane;
10.02. Membrane housing;
10.03 Inlet water solenoid valve;
10.04. High pressure pump;
10.05. Flow sensor;
10.06. Pressure gauge (low pressure monitor);
10.07. Pressure gauge (high pressure monitor);
10.08. Pressure switch;
10.09. Filter housing;
10.10. Cartridge filter;
10.11. Antiscalant dosing pump;
10.12. Antiscalant solution tank;
10.13. Dry chemical dissolving tank antiscalant;
10.14. Regulating pressure valve;
10.15. Mixed water solenoid valve;
10.16. Flowmeter;
10.17. Recirculating valve;
10.18. Reject valve;
11. Hardness monitoring system;
12. Ozone system;
12.1. Venturi injector;
12.2. Bypass valve;
13. Circulating pump;
14. Filter housing;
15. Post filtration cartridge;
16. UV light system;
18. Level sensor high level BTSS treated water;
18.1 Level sensor low level BTSS treated water;
17. Level sensor high level AST treated water;
17.1. Level sensor low level AST treated water;
19. Wash/rinse water nozzles;
20. Hot air sealing gun;
21. Rinse and wash pump;
21.1 Detergent addition subsystem;
22.1. Solenoid fill valve (normally closed);
22.2. Solenoid fill valve (normally opened);
22.3. Snap head filler system;
22.4. Filling assembly (bottle specific);
23. Filling head nozzle;
24. Washing solution tank;
31. Raw water storage tank (RWT);
32. Additional storage tank (AST);
34. Centrifugal pump adapted to pump water from a raw water source to CT 1; and/or
35. Centrifugal pump adapted to pump chlorine treated water to CFT 4, etc.

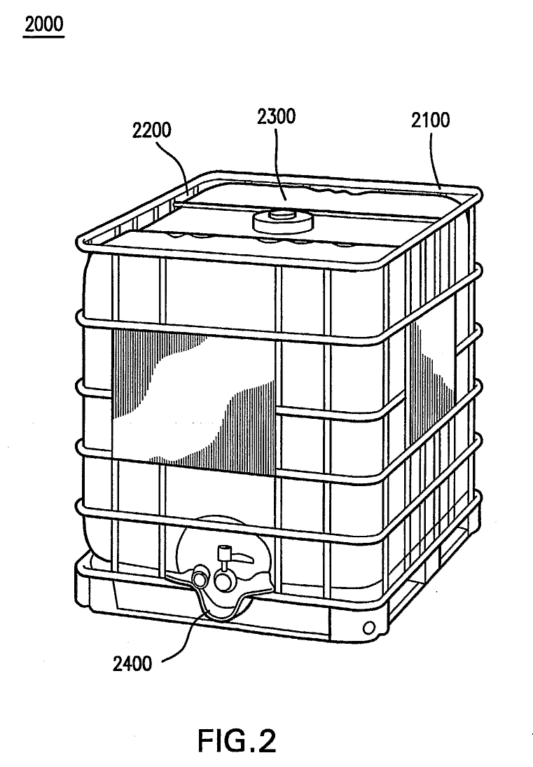

FIG. 2 is a photograph of an exemplary embodiment of a system 2000, which can comprise a cage 2100. Cage 2100 can define a chamber 2200, which can at least partially surround a tank 2300. Tank 2300 can be adapted for water storage. In certain exemplary embodiments, tank 2300 can be a substantially non-destructively collapsible water storage tank. In certain exemplary embodiments, tank 2300 can be a substantially non-collapsible water storage tank. Cage 2100 can rest and/or be connected to a base 2400. Base 2400 can be a platform, plate with lifting eyes and/or lugs, pallet, and/or cage extension, etc. System 2000 can be lifted and/or relocated with a lifting device via base 2400.

In certain exemplary embodiments, cage 2100 can have a substantially cuboid shape. In certain exemplary embodiments, tank 2300 can have a substantially cuboid shape and can be adapted to be substantially contained by cage 2100.

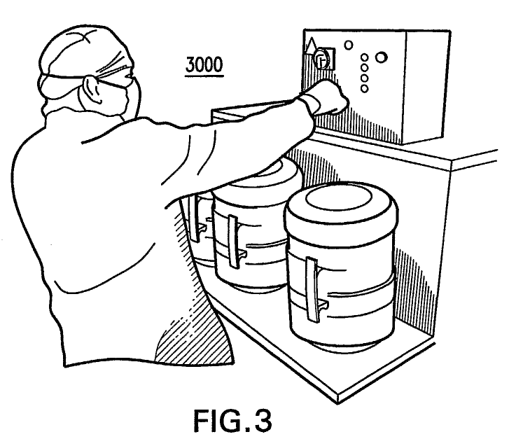

FIG. 3 is a photograph of an exemplary embodiment of a system 3000.

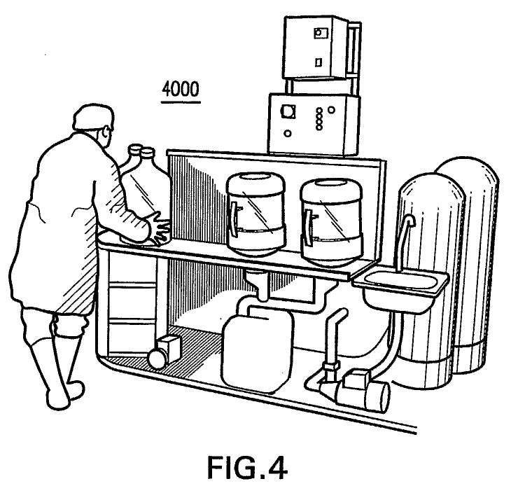

FIG. 4 is a photograph of an exemplary embodiment of a system 4000.

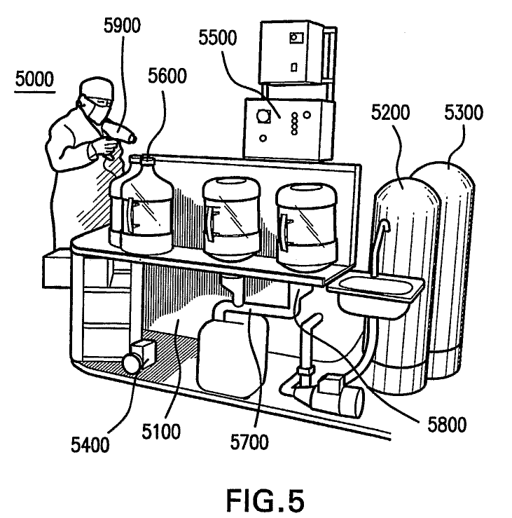

FIG. 5 is a photograph of an exemplary embodiment of a system 5000, which can comprise a sub-plurality of water treatment components, such as first vessel 5200 and second vessel 5300, which are mounted to a cage 5100. The sub-plurality of water treatment components can be external to a chamber defined by cage 5100, as illustrated in FIG. 5. The sub-plurality of water treatment components can be comprised by a plurality of water treatment components, such as the plurality of water treatment components illustrated in FIG. 1.

System 5000 can comprise a platform 5400, which can be adapted to support one or more of the sub-plurality of water treatment components. Via platform 5400, system 5000 can be skid mounted and/or adapted to be movable by a lifting device. In certain exemplary embodiments, system 5000 can be transported by and/or mounted on a mobile trailer. In certain exemplary embodiments, system 5000 can be placed in a protective container and thereby can be containerized to reduce a probability of damage to components of system 5000.

System 5000 can comprise a control system 5500, which can be adapted to regulate at least one flow associated with system 5000. In certain exemplary embodiments, control system 5500 can comprise a programmable logic controller. Control system 5500 can be adapted to monitor hardness and/or conductivity of a non-potable water input and/or a potable water output of system 5000.

System 5000 can comprise a bottling subsystem 5600, which can be adapted to package water treated by system 5000. Bottling subsystem 5600 can be adapted to be mounted on cage 5100. Bottling subsystem 5600 can comprise a hot air gun 5900, which can be adapted to seal bottle caps of water bottled via system 5000. System 5000 can comprise a bottle cleaning subsystem 5700, which can be adapted to clean a bottle prior to the bottle receiving water treated by system 5000. Bottle cleaning subsystem 5700 can comprise a bottle washing injector 5800.

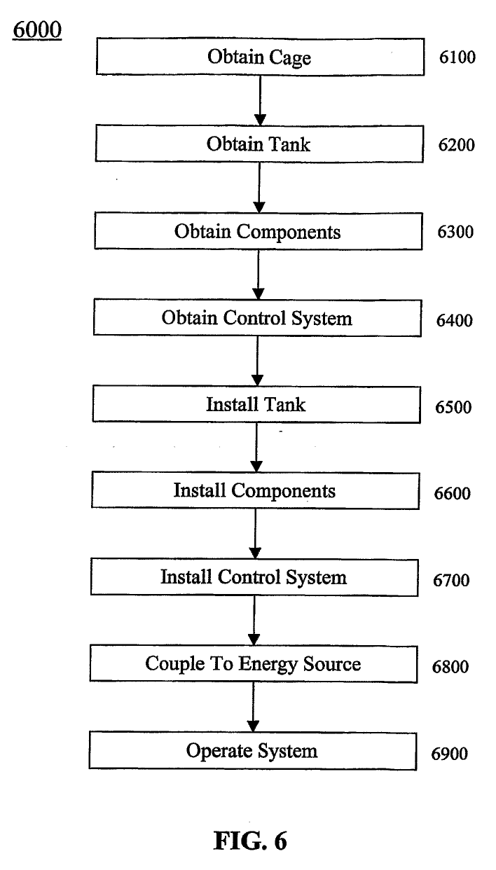

FIG. 6 is a flowchart of an exemplary embodiment of a method 6000. At activity 6100, a cage can be obtained. The cage can be manufactured from rods, pipes, and/or bars, etc. The cage can be constructed of a material that can be relatively rigid such as carbon steel, stainless steel, aluminum, brass, bronze, copper, polymer, and/or thermoplastic, etc.

At activity 6200, a tank can be obtained. The tank can be made of a plastic material such as HDPE, polypropylene, and/or fiberglass, etc. The tank can be a substantially metallic tank, which can comprise carbon steel, stainless steel, aluminum, brass, bronze, and/or copper, etc.

At activity 6300, a plurality of water treatment components can be obtained. In certain exemplary embodiments, the plurality of water treatment components can comprise chlorination components, particle filtration components, organic filtration components, demineralization components, water blending components, UV disinfectant components, ozone treatment components, and/or silver ion dosage components, etc.

At activity 6400, a control system can be obtained. The control system can comprise hardware, firmware, and/or software adapted to monitor and control a water treatment system. The control system can be adapted to monitor and/or regulate flows, temperatures, pressures, backwash sequences, bottle washing, and/or bottle filling operations, etc. In certain exemplary embodiments, the control system can comprise a PLC.

At activity 6500, the tank can be installed. The tank can be installed in the cage. The tank can be protected and/or contained by the cage. In certain exemplary embodiments, the tank can be substantially collapsible and can be at least partially supported by the cage. The shape of the tank and/or the cage can be substantially cuboid.

At activity 6600, the plurality of water treatment components can be installed. The plurality of water treatment components can be installed on, attached to, and/or supported by the cage. The plurality of water treatment components can rest atop the tank/cage system and/or can be attached directly or indirectly to walls defined by the cage. Each of the plurality of water treatment components can be electrically and/or hydraulically coupled to form a water treatment system.

At activity 6700, the control system can be installed. The control system can be adapted to allow the water treatment system to be operated by a single operator. In certain exemplary embodiments, most system operation functions can be performed via a single button.

At activity 6800, the plurality of water treatment components can be coupled to an energy source. The energy source can be an electrical power distribution grid operated by a utility. The energy source can be a relatively portable electrical generator deriving energy from a petroleum based fuel and/or from hydrogen via a fuel cell.

At activity 6900, the system can be operated. The system can receive an untreated and/or non-potable input and can be adapted to produce a potable water output. In certain exemplary embodiments, water produced from the water treatment system can be bottled for distribution.

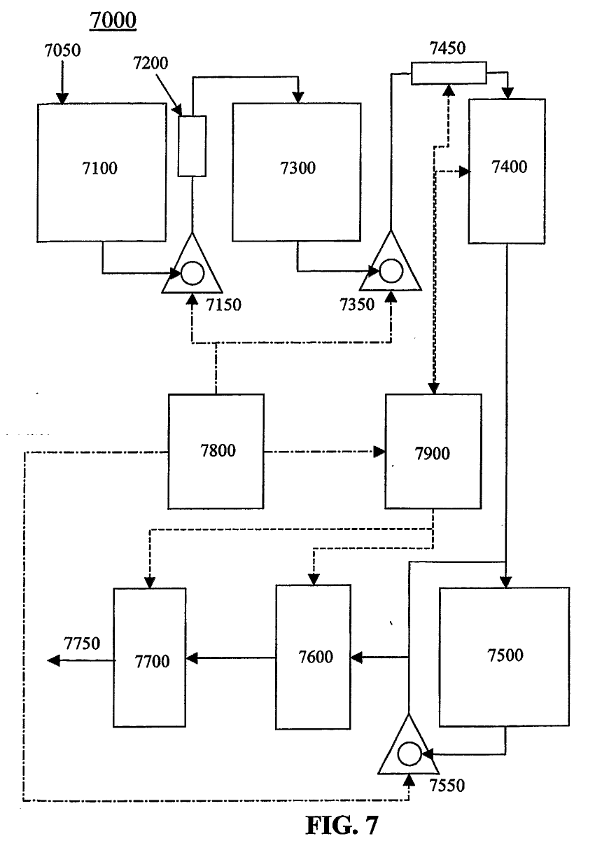

FIG. 7 is a block diagram of an exemplary embodiment of a system 7000, which can be a water treatment system. In certain exemplary embodiments, system 7000 can be skid mounted and can be adapted to be movable by a lifting device.

System 7000 can receive a raw water input 7050. The raw water input can be from a river, lake, stream, ocean, sewage treatment facility, and/or wastewater generation facility, etc. Raw water input 7050 can be routed to a raw water storage tank 7100. Water can be transferred from raw water storage tank 7100 to a chlorinated water storage tank 7300 via a first pump 7150. Water pumped via pump 7150 can flow to chlorinated water storage tank 7300 via a chlorinator 7200. Chlorinator 7200 can be adapted to add, mix, and/or inject chlorine into the water in an amount sufficient for disinfection. For example, the chlorinator can add chorine, in mg/l, at a dosage level of 2.0, 1.75, 1.2, 1, 0.95, 0.6, 0.5, 0.25, or any value or subrange therebetween.

Water can be transferred from chlorinated water storage tank 7300 to a plurality of water treatment components 7400 via a pump 7350. Plurality of water treatment components 7400 can comprise a particle filter, carbon filter, reverse osmosis membrane, and/or cartridge filter, etc. One or more properties of the water can be measured via a sensor 7450. Sensor 7450 can be adapted to measure temperature, pressure, flow, conductivity, hardness, level, and/or pH, etc.

Water can pass from plurality of water treatment components 7400 to a finished water storage tank 7500. Finished water storage tank 7500 can be at least partially surrounded by a cage (not illustrated) adapted to support at least a sub-plurality of plurality of water treatment components 7400. The cage and/or finished water storage tank 7500 can have a substantially cuboid shape. The cage can define an interior chamber that at least partially surrounds finished water storage tank 7500. In certain exemplary embodiments, the sub-plurality of water treatment components can be mounted to the cage and can be external to the interior chamber. Finished water storage tank 7500 can be substantially non-destructively removable from the interior chamber. The cage can be adapted to support a platform. The platform can be adapted to support one or more of the sub-plurality of water treatment components.

Water can be transferred from finished water storage tank 7500 to a finished water polishing system 7600 via a pump 7550. Pump 7550 can be adapted to recirculate water to finished water storage tank 7500 to provide for uniformity of composition of water comprised therein. Water polishing system 7600 can comprise a fine particulate filter and/or membrane, ozone addition system, silver ion addition system, and/or UV light system, etc.

In certain exemplary embodiments, water treated by system 7000 can be packaged via a bottling subsystem 7700. Bottling subsystem 7700 can be adapted to clean bottles, fill bottles with water, and/or cap filled bottles, etc. Water can exit the system, bottled or otherwise packaged, via a water outlet 7750. Bottling subsystem can be adapted to be mounted on the cage. Bottling subsystem 7700 can comprise a hot air gun, which can be adapted to seal bottle caps. Bottling subsystem 7700 can be adapted to clean a bottle prior to the bottle receiving water treated by system 7000. Bottle subsystem 7700 can comprise a bottle cleaning subsystem, which can comprise a bottle washing injector.

System 7000 can comprise and/or can be coupled to an energy source 7800. Energy source 7800 can be adapted to provide electrical energy to one or more components of water treatment system 7000, such as a pump 7150, pump 7350, pump 7550, and/or a control system 7900. Energy source 7800 can provide energy to a plurality of instruments and/or process equipment (some of which might not be illustrated) comprised by system 7000. Energy source 7800 can be an electrical energy source from an electrical utility and/or a generator, such as a generator powered by solar panels, gasoline, propane, kerosene, natural gas, and/or diesel fuel, etc.

Control system 7900 can comprise a programmable logic controller. Control system 7900 can receive information related to system 7000 from a plurality of sensors (not illustrated), which can monitor pressures, flows, and/or chemical compositions of various flow streams of system 7000. Control system 7900 can be adapted to regulate various flows and equipment cycles in system 7000. For example, control system 7900 can be adapted to perform backwash cycles of certain water treatment equipment comprise in plurality of water treatment components 7400. Control system 7900 can be adapted to control pump motor speeds, valve positions, and/or water throughput rates, etc. Control system 7900 can be adapted to monitor water hardness and/or water conductivity.

### Note

Still other practical and useful embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application.

Thus, regardless of the content of any portion (e.g., title, field, background, summary, abstract, drawing figure, etc.) of this application, unless clearly specified to the contrary, such as via an explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, performed by multiple entities, and/or performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Any information in any material (e.g., a U.S. patent, U.S. patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

Accordingly, the descriptions and drawings are to be regarded as illustrative in nature, and not as restrictive.

What is claimed is:

1. A system comprising:
a cage defining an interior chamber that at least partially surrounds a water storage tank, said water storage tank substantially non-destructively removable from said interior chamber; and
a sub-plurality of water treatment components of a plurality of water treatment components, said plurality of water treatment components adapted to receive a non-potable water input and to provide a potable water output, said sub-plurality of water treatment components mounted to said cage and external to said interior chamber, said plurality of water treatment components comprising a reverse osmosis membrane.

2. The system of claim 1, wherein:
said cage has a substantially cuboid shape.

3. The system of claim 1, wherein:
said water storage tank has a substantially cuboid shape.

4. The system of claim 1, further comprising:
a control system adapted to regulate at least one flow associated with said system.

5. The system of claim 1, further comprising:
a control system adapted to regulate at least one flow associated with said system, said control system comprising a programmable logic controller.

6. The system of claim 1, further comprising:
a control system adapted to monitor water hardness.

7. The system of claim 1, further comprising:
a control system adapted to monitor water conductivity.

8. The system of claim 1, further comprising:
a bottling subsystem adapted to package water treated by said system, said bottling subsystem adapted to be mounted on said cage.

9. The system of claim 1, further comprising:
a bottle cleaning subsystem adapted to clean a bottle prior to said bottle receiving water treated by said system, said bottle cleaning subsystem comprising a bottle washing injector.

10. The system of claim 1, further comprising:
a bottling subsystem adapted to receive water treated by said system, said bottling subsystem comprising a hot air gun, said hot air gun adapted to seal bottle caps.

11. The system of claim 1, wherein said plurality of water treatment components comprises an ultrafiltration membrane.

12. The system of claim 1, wherein said plurality of water treatment components comprises an activated carbon filter.

13. The system of claim 1, wherein said plurality of water treatment components comprises an ozone addition system.

14. The system of claim 1, wherein said plurality of water treatment components comprises a polishing filter adapted to remove particulates from treated water.

15. The system of claim 1, wherein said plurality of water treatment components comprises an ultraviolet lamp.

16. The system of claim 1, wherein said plurality of water treatment components comprises of at least one sensor.

17. The system of claim 1, wherein said cage is adapted to support a platform, said platform adapted to support one or more of said sub-plurality of water treatment components.

18. The system of claim 1, wherein said system is skid mounted.

19. The system of claim 1, wherein said system is adapted to be movable by a lifting device.

20. A system comprising:
a cage defining an interior chamber that at least partially surrounds a water storage tank, said water storage tank substantially non-destructively removable from said interior chamber; and
a sub-plurality of water treatment components of a plurality of water treatment components, said plurality of water treatment components adapted to receive a non-potable water input and to provide a potable water output, said sub-plurality of water treatment components mounted to said cage and external to said chamber, said plurality of water treatment components comprising a particle filter.

21. A system comprising:
a cage adapted to support a sub-plurality of water treatment components of a plurality of water treatment components, said plurality of water treatment components adapted to receive a non-potable water input and to provide a potable water output, said cage defining a chamber adapted to at least partially surround a water storage tank, said sub-plurality of water treatment components adapted to be mounted to said cage and external to said chamber.
